(19) United States
(12) Patent Application Publication
(10) Pub. No.: US 2011/0136451 A1
(43) Pub. Date: Jun. 9, 2011

(54) TELECOMMUNICATION DEVICE HAVING A LOOP-SUPPLIED DEVICE AND METHOD FOR THE OPERATING VOLTAGE SUPPLY THEREOF

(75) Inventors: Daniel SCHRAG, Lufingen (CH); Yannick MARET, Rutihof (CH)

(73) Assignee: ABB Technology AG, Zurich (CH)

(21) Appl. No.: 12/966,417

(22) Filed: Dec. 13, 2010

Related U.S. Application Data
(63) Continuation of application No. PCT/EP2009/004234, filed on Jun. 12, 2009.

(30) Foreign Application Priority Data
Jun. 12, 2008 (DE) 10 2008 028 191.3
Jun. 9, 2009 (DE) 10 2009 024 853.6

(51) Int. Cl. H04W 52/00

(52) U.S. Cl. 455/127.1

(57) ABSTRACT

A telecommunication device has a power-supplying receiving device, and a transmitter device supplied by the receiving device via a current loop for the output of at least one variable measurement value. The measurement value is imprinted on the loop current. The telecommunication device also includes an additional appliance supplied from the current loop. The additional appliance includes a control device for adaptively adjusting its operating voltage relative to the loop current as a function of the current power requirement. The control device reduces the operating voltage up to a minimum operating voltage value upon increasing loop current in a reversed proportional manner to the loop current, and keeps the operating voltage constant in case of a further increase of the loop current in a loop current independent manner.

### RELATED APPLICATIONS

This application claims priority as a continuation application under 35 U.S.C. §120 to PCT/EP2009/004234, which was filed as an International Application on Jun. 12, 2009 designating the U.S., and which claims priority to German Application 10 2008 028 191.3 filed in Germany on Jun. 12, 2008 and German Application 10 2009 024 853.9 filed in Germany on Jun. 9, 2009. The entire contents of these applications are hereby incorporated by reference in their entireties.

### FIELD

The present disclosure relates to a telecommunication device (e.g., a telemetry device) having a power-supplying receiving device, a transmitter device, which is fed from the receiving device via a current loop for outputting at least one variable measured value, which is applied to the loop current, and an additional device in the current loop. The present disclosure also relates to a method for supplying an operating voltage to the telecommunication device.

The field of use of the present disclosure extends to industrial automation installations for process technology, the automobile industry, the foodstuffs industry, and the like. Industrial installations that are of interest here include, for example, electronically controllable appliances, such as valves, motors, sensor appliances, which communicate with one another and with at least one superordinate controller, in analog and/or digital form, via a network.

### BACKGROUND INFORMATION

HART (Highway Addressable Remote Transducer) is one example of a standardized, widely used communication system for setting up industrial fieldbuses. The HART system allows digital communication between appliances which are integrated therein, via a common data bus. Such appliances are referred to as HART-compatible appliances. In this case, HART is based specifically on the likewise widely used 0/4 to 20 mA standard for transmission of analog sensor signals via a current loop. The variable range between 4 and 20 mA represents the measured value or set value of the field appliance, while the fixed basic current of 4 mA is used for the electrical supply of the field appliance.

DE 197 23 645 A1 describes an arrangement for signal transmission between a transmitter point and a receiving point, in which the operating voltage for the transmitter point is produced by a switched-mode regulator, which outputs a constant output voltage and whose output power, apart from losses, is equal to its input power. With a basic current, which is constant in accordance with the agreement, for supplying the transmitter point, the input power of the transmitter point is adapted in order to match the input power to the required output power.

Depending on the measured value to be transmitted, whose range is based on a current of 0 to 16 mA, and the fixed basic current of 4 mA for the electrical supply for the transmitter point, a voltage which is dependent on the line length of the current loop is created at the terminals of the transmitter point.

Recently, the HART standardization organization has defined a new HART Standard, which is devoted to wire-free signal transmission. The radio transmission which is used in this case is based on the wire-free IEEE 802.15.4 communication standard, and uses TDMA as the transmission method. With this new wire-free HART Standard, it is now possible to easily integrate HART appliances communicating without the use of wires into existing systems. When the intention is to integrate HART appliances which communicate without the use of wires into the existing, cable-based system, then they must also be supplied with the necessary electrical power via the current loop carrying the HART signals, and they also have to communicate internally, with or without the use of wires, with further HART appliances or control units which communicate without the use of wires.

While additional appliances or devices, such as handheld appliances (handheld terminals) or HART appliances which communicate without the use of wires, are included in the current loop which carries measured values, the loop current must remain unchanged, and the voltage drop across the additional appliance must be sufficiently small such that the transmitter device being fed still operates correctly. Because of considerable line lengths of several 100 m, for example, within large systems, the voltage drop across the current loop is therefore of a different magnitude. This voltage drop is calculated using Ohm's Law, based on the resistance of the current loop and the instantaneous loop current. The operating voltage, which the receiving device provides, is split between the transmitter point, the voltage drop across the current loop and the voltage of the additionally provided HART appliances which communicate without the use of wires. The supply voltage is often only just sufficient for one single additional field appliance, with a limited line length.

DE 10 2006 009 979 A1 discloses a device for wire-free communication with a field appliance, which has a communication unit for conversion of cable-based communication to wire-free communication. Without a feeding current loop, the disclosed device is fed from a local energy store. This local energy store is also used to supply the operating voltage to the connected field appliance. In order to minimize the energy consumption and therefore to lengthen the life of an integrated energy store, an energy management unit is provided, by means of which the connected field appliance can be supplied with the necessary operating energy and predetermined operating times.

The measure of supplying operating energy to the HART appliance only at predetermined operating times, with this energy then being provided by an energy store, involves significant additional technical complexity. For example, the life of the energy store should be checked in maintenance intervals. It has been proposed to switch off the operating energy for the HART appliance, which communicates without the use of wires, in predeterminable rest times, in which no communication is intended, by means of the energy management unit. However, this proposal leads to correspondingly restricted availability of the entire system. Furthermore, it is not possible to predict whether operating times with a low power consumption will be sufficiently available for charging the energy store. Continuous operation, independent of the power consumption of the signal transmitter, is therefore difficult to achieve.

This technical solution therefore requires periodic maintenance of the local energy store, which affects the availability of devices, and increases the labor effort on operators of such devices.

### SUMMARY

An exemplary embodiment of the present disclosure provides a telecommunication device. The exemplary telecommunication device includes a current loop, a feeding receiving device, and a transmitter device. The transmitter device is fed from the receiving device via the current loop, for outputting at least one variable measured value to be applied to the loop current. The transmitter device is configured for simultaneous bidirectional communication via the current loop. The telecommunication device also includes an additional appliance configured to be fed from the current loop, to bidirectionally communication via the current loop and, and to feed from the current loop. The additional appliance includes control means for adaptive operating voltage matching to the loop current as a function of the instantaneous power demand. The control means reduce an operating voltage of the additional appliance in inverse proportion to the loop current, down to a minimum operating voltage value, when the loop current rises, and stabilize the operating voltage of the additional appliance, independent of the loop current, when the loop current rises further than when the control means reduces the operating voltage to the minimum operating voltage value.

An exemplary embodiment provides a method for supplying an operating voltage to appliances in a telecommunication device having a feeding receiving device, a current loop, and a transmitter device, which is fed via the current loop from the receiving device for outputting at least one variable measured value to be applied to the loop current. The exemplary method includes providing at least one additional appliance on the current loop. The exemplary method also includes adaptively matching an operating voltage of the additional appliance to an instantaneous loop current, such that the operating voltage is decreased in inverse proportion to the loop current, down to a minimum operating voltage value, when the loop current rises, and the operating voltage is stabilized at the minimum operating voltage value, independent of the loop current, when the loop current rises further than when the control means reduces the operating voltage to the minimum operating voltage value.

An exemplary embodiment of the present disclosure provides a telecommunication device. The exemplary telecommunication device includes a current loop, a feeding receiving device, and a transmitter device. The transmitter device is fed from the receiving device via the current loop, for outputting at least one variable measured value to be applied to the loop current. The transmitter device is configured for simultaneous bidirectional communication via the current loop. The telecommunication device also includes an additional appliance configured to be fed from the current loop, to bidirectionally communication via the current loop and, and to feed from the current loop. The additional appliance includes a control device configured to adaptive match an operating voltage to the loop current as a function of the instantaneous power demand. The control device is configured to reduce an operating voltage of the additional appliance in inverse proportion to the loop current, down to a minimum operating voltage value, when the loop current rises, and stabilize the operating voltage of the additional appliance, independent of the loop current, when the loop current rises further than when the control means reduces the operating voltage to the minimum operating voltage value.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a schematic illustration of an exemplary telecommunication device according to an embodiment of the present disclosure;

FIG. 2 shows an illustration, in the form of a block diagram, of an exemplary additional device with an operating voltage supply from the current loop as shown in FIG. 1, according to an embodiment of the present disclosure; and

FIG. 3 shows an illustration, in the form of a graph, of a U/I operating curve for a control means for adaptive operating voltage matching, according to an embodiment of the present disclosure.

### DETAILED DESCRIPTION

Exemplary embodiments of the present disclosure add an additional appliance to the above-described telecommunication device (e.g., telemetry device) having a feeding receiving device and a transmitter device which is fed via a current loop from the receiving device. In accordance with exemplary embodiments of the present disclosure, the additional appliance can be integrated in the same current loop in a technically simple manner and without restricting the availability of the entire system.

Exemplary embodiments of the present disclosure therefore provide a telecommunications device having a feeding receiving device, a transmitter device, which is fed from the receiving device via a current loop for outputting at least one variable measured value for application to the loop current, and which is designed for simultaneous bidirectional communication via the current loop, and at least additional device on the current loop, as described below.

Exemplary embodiments of the present disclosure can be based on an assumption that an already installed current loop including a feeding receiving device, line and fed transmitter device always has a sufficiently large reserve to also allow an adaptor with a small power consumption to be included subsequently in the loop. Because of the voltage drop on the line, the reserve is at a minimum when the currents are high. In this case, in contrast to an active transmitter device with a high power consumption which influences the current in the loop (for example, >40 to 200 mW depending on the current drawn), a purely passive adaptor with a low power consumption (for example, <10 mW) requires such a small feed power that this is covered by the reserve in the installed current loop.

According to exemplary embodiments of the present disclosure, the current loop has an additional appliance, which is fed from the current loop and is designed for bidirectional communication via the current loop. In order to feed it from the current loop, this additional appliance can be equipped with control means for adaptive operating voltage matching to the instantaneous loop current as a function of the instantaneous power demand. These control means reduce the operating voltage for the additional appliance in inverse proportion to the loop current, down to a minimum operating voltage value, when the loop current rises. When the loop current rises further, the operating voltage is stabilized at the minimum operating voltage value, independent of the loop current.

When the loop current is low, because an analog measured value at the lower limit of its range is being transmitted, the voltage drop across the resistance of the current loop is low. The reserve from which the further appliance is fed is therefore large. When the loop current is high because a measured value is being transmitted in analog form at the upper limit of its range, the voltage drop across the resistance of the current loop is correspondingly high. The reserve is then at its minimum but, because of the high loop current, the required power for a passive adaptor with low power consumption can nevertheless be drawn from the current loop without any disturbance.

Exemplary embodiments of the present disclosure can be fitted to an existing current loop and, in this case, can be supplied with the power required to operate it from this current loop. For instance, the generally higher power consumption of field appliances which communicate without the use of wires can also be coped with in this way. Since the voltage is a limiting variable, it is advantageous for the voltage drop to remain as low as possible. By the dynamic adaptation of the operating voltage of the appliance to the loop current instantaneously flowing in the current loop, exemplary embodiments of the disclosure present disclosure can lead to the respectively lowest voltage drop.

The control means for adaptive operating voltage matching can be implemented in those field appliances which have a constant power consumption. In these field appliances, the measured value or the signal does not fluctuate and, derived from Ohm's Law, the operating voltage conditions are constant. Because the efficiency of a field device is dependent on the voltage, the relationship may also in some circumstances be non-linear.

However, it is also feasible to implement adaptive operating voltage matching to fluctuating power requirements. These can be produced, for example, in the event of fluctuating communication frequencies on the current loop. Communication frequencies of this type are set depending on the speed of the industrial process. For rapid processes, communication takes place more frequently between the field appliances than in the case of slow processes, resulting in a higher power consumption. The control means according to exemplary embodiments of the present disclosure can be adjusted for such fluctuating conditions.

The control means for adaptive operating voltage matching can have a current sensor unit for measuring the instantaneous loop current in the current loop. In this case, the magnitude of the current in the 0/4 to 20 mA current loop can be a measure of the instantaneous measured value. The time profile of the current may include further information, for example a digital bus signal, which, after filtering out, is passed onto a downstream evaluation unit for further processing.

It is also proposed that this current sensor unit be followed, for the purposes of the control means, by a filter unit for separation of the useful signal, which is used for operating voltage matching, in the low frequency range from the communication signal in the high frequency range. This optional filtering does not adversely affect the communication, since no voltage adaptation is carried out in the frequency ranges which are relevant for communication. There may be no need for such a filter unit if the communication is sufficiently robust to accept a disturbance caused by the voltage adaptation.

The current sensor unit or—if present—the downstream filter unit is followed, according to an additional feature of the present disclosure, by a voltage preset unit which defines the value for the operating voltage U_{W} in accordance with a defined U/I operating curve, on the basis of the instantaneous loop current. In this way, a voltage is defined in accordance with the predetermined operating curve, for example, based on the previously filtered signal, which corresponds to the filtered current. This operating curve is obtained from constraints such as the maximum power consumption and the minimum operating voltage, is defined in a corresponding manner, and is stored in the voltage preset unit. This operating curve may be adapted on the basis of further variables, such as the ambient temperature, component tolerances of the electronic components, safety margins to increase the operational reliability of the system, and the instantaneous power consumption.

The control means can also have a voltage control unit, which is connected downstream from the voltage preset unit, as a control element for setting the operating voltage U_{W} for the further appliance.

The voltage preset unit sets the voltage drop between a positive and a negative range, in accordance with the predetermined difference.

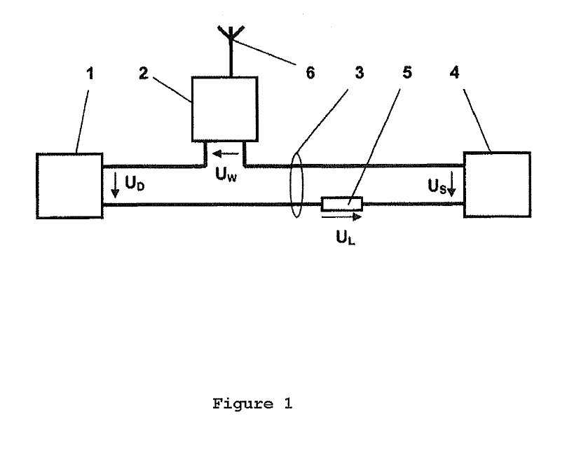

FIG. 1 shows a telecommunication device according to an exemplary embodiment of the present disclosure. The exemplary telecommunication device illustrated in FIG. 1 can be a telemetry device, for example. The telecommunication device has a feeding (power-supplying) receiving device 4 and a transmitter device 1, which is fed (e.g., powered) from the receiving device 4 via a current loop 3, for outputting at least one variable measured value. The measured value determined in the transmitter device 1 is applied to the loop current. According to an exemplary embodiment, only the transmitter device 1 can influence the loop current. Furthermore, the transmitter device 1 can be designed for simultaneous bidirectional communication via the current loop 3. This can be implemented using the HART protocol, for example.

In order to illustrate the electrical relationships in the current loop 3, FIG. 1 shows a line resistance 5 as a concentrated component, which equivalently represents the resistance of the connecting line which forms the current loop 3.

At its terminals, the feeding receiving device 4 emits a predetermined, constant feed filter U_{S}. A loop current flowing through the current loop 3 is the same throughout the entire network. The current level of the loop current is governed by the transmitter device 1, and is composed of a constant basic current for supplying the transmitter device 1 and a variable current, which represents the measured value. In the case of the 0/4 to 20 mA current loop that can be used in the industrial environment, the basic current is 4 mA and the range of the measured value is mapped onto the variable current of 0 to 16 mA.

In order to operate correctly, the transmitter device 1 requires an operating voltage U_{D} at its terminals, which must not be less than a minimum value.

The loop current produces a voltage drop U_{L} across the line resistance 5, which, for a given line length, rises as the loop current rises, and reaches its maximum value at the maximum loop current of 20 mA. A maximum permissible line resistance 5 results as a limiting parameter for the physical extent of the current loop 3, from the minimum value of the operating voltage U_{D} for the transmitter device 1 and the predetermined, constant feed voltage U_{S} at the terminals of the receiving device 4.

Furthermore, a further appliance (e.g., device) 2 is integrated in the current loop 3. The additional appliance 2 is designed for bidirectional communication via the current loop 3, and an operating voltage U_{W} is dropped across the terminals of the additional appliance 2.

In an accordance with an exemplary embodiment of the present disclosure, the additional appliance 2 can be in the form of a remote display device for displaying the measured value, and/or state data from the transmitter device 1. The data from the transmitter device(s) 1 where accessibility is difficult can thus also advantageously be displayed in situ.

In accordance with an exemplary embodiment of the present disclosure, the additional appliance 2 can be in the form of a remote control device for configuration of the transmitter device 1. This arrangement also advantageously allows transmitter device(s) 1 to be configured in situ where accessibility is difficult. In accordance with an exemplary embodiment, the additional appliance 2 can be in the form of a combined display and control device.

In accordance with an exemplary embodiment of the present disclosure, the additional appliance 2 can be designed for wire-free communication with a superordinate device. In this case, it is possible to interchange the measured value and/or state data of the transmitter device 1 and/or configuration data for the transmitter device 1. The additional appliance 2 can be equipped with an integrated radio unit 6, for example, for this purpose.

In each of the described exemplary embodiments, the additional appliance 2 is fed from the current loop 3.

By way of example, the transmitter device 1 can be a measurement instrument for a physical variable in a process installation, while the additional appliance 2 represents an adaptor, which transmits the measured value of the physical variable via an integrated radio unit 6 to a superordinate device, without the use of wires.

The electrical power which is required to carry out the functions of the transmitter device 1 and of the additional appliance 2 is transmitted via the current loop 3. In this case, the additional appliance 2 has control means (e.g., control circuitry) for adaptive operating voltage matching to the current loop as a function of the instantaneous power demand, which reduces the operating voltage U_{W} of the additional appliance 2 proportionally down to a defined minimum operating voltage value Uₘᵢₙ when the loop current in the current loop 3 is high, and stabilizes the operating voltage U_{W}, independent of the loop current, when the loop current rises further.

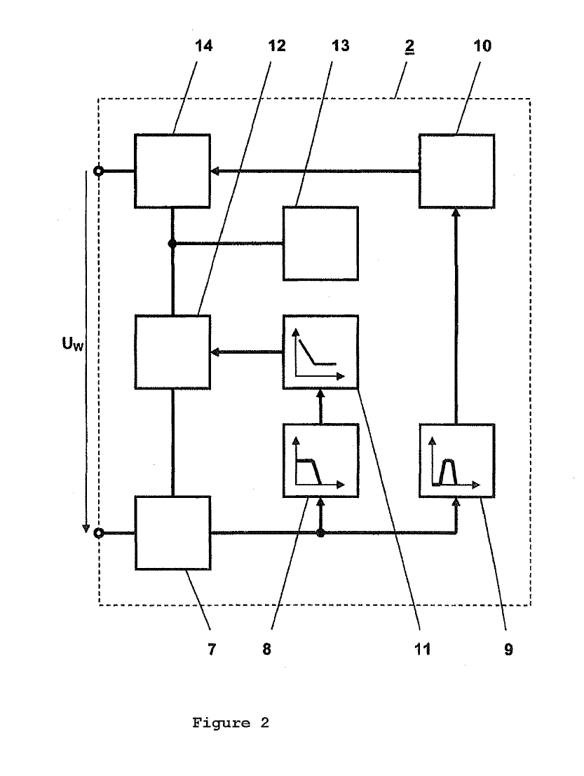

FIG. 2 shows a block diagram of the additional appliance 2 which, in an effect chain, first of all has a current sensor unit 7 for measuring the instantaneous loop current in the current loop 3. This is followed by a filter unit 8. The filter unit 8 is used to separate the useful signal, which is used for operating voltage matching, in the low frequency range from the communication signal in the high frequency range. The communication signal is supplied via a further filter unit 9 to a control unit 10 for further signal processing. The filter unit 8 is in turn followed by a voltage preset unit 11, which defines the value for the operating voltage U_{W} in accordance with a defined U/I operating curve, which will be explained in more detail below, on the basis of the instantaneous loop current.

The voltage present unit 11 is in turn followed by a voltage control unit 12 for setting the operating voltage U_{W} for the additional appliance 2. Within the control means, a direct-current converter 13 and a modulator unit 14, which is integrated in the current loop 3, are also provided, are supplied with useful data on the input side from the control unit 10, and this useful data is modulated onto the loop current in the current loop 3.

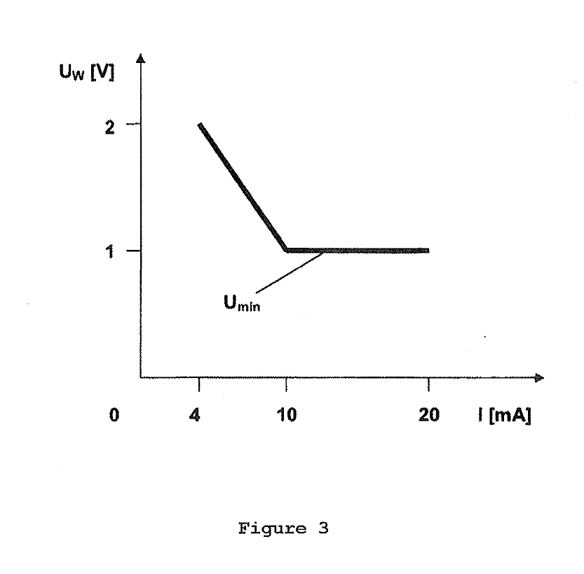

The U/I operating curve illustrated in FIG. 3 can be stored in the receiving device and/or in the additional appliance 2. The transmitter device 1, the receiving device 4 and/or the additional appliance 2 can include a non-transitory computer-readable recording medium, such as a non-volatile memory (e.g, ROM, a hard disk drive, optical memory, flash memory, etc.). The U/I operating curve can be used to define a matched operating voltage U_{W} on the basis of the instantaneously flowing loop current in the current loop 3. In this case, the curve profile also takes account of further operating parameters in the sense of correction factors, such as the ambient temperature and the like. The U/I operating curve furthermore defines a minimum operating voltage value Uₘᵢₙ, which in this example is one volt.

When the power conditions are constant, the operating voltage U_{W} of the connected additional appliance 2 is regulated with the aid of the U/I operating curve, on the basis of the measured loop current and the requirements of the components used, as well as the specification, such that this is as low as possible at all times. When the additional appliance 2 is communicating without the use of wires, then the operating voltage U_{W} is composed of the minimum input voltage of the direct-current converter 13, the power demand for the electronics for producing the useful signal, and the efficiency and the amplitude of the modulation signal. On the basis of the stated conditions, the stored function makes it possible to automatically reduce the operating voltage U_{W} in order to achieve a minimum input voltage.

In accordance with an exemplary embodiment, the additional appliance 2 can have its own measurement unit, by means of which further measurement variables can be recorded, for example, in the memory of the additional appliance 2. In addition to the loop current, these additional measurement values can include, for example, the respective voltage drop at the transmitter device 1 as well as process variables which are independent of the transmitter device 1 itself, such as flow, temperature or pressure, which are recorded by the transmitter device 1.

In accordance with an exemplary embodiment of the present disclosure, the transmitter device 1 can be in the form of a flowmeter, and the additional appliance 2 can be in the form of a pressure measurement module, which is included in the conductor loop for signal transmission and supply. When the additional appliance 2 transmits the pressure as an additional measurement variable to the transmitter device 1, the additional appliance 2 can calculate and output the mass flow.

Alternatively, the additional appliance 2 could also use the volume flow and pressure to determine the mass flow, and could communicate this to the transmitter device 1 or to the receiving device 4. Furthermore, it is possible for the measured values and/or process values derived from the measured values to be recorded in an internal non-transitory computer-readable memory, in order to use them for subsequent evaluation or checking.

Furthermore, it is possible for the additional appliance 2 to generate one or more variables for correction, conversion, control and/or diagnosis of one or more transmitter devices 1, for example. In this way, it is feasible to produce a subsystem for complex measurements from a plurality of variables or specific control functions from a further appliance 2, which is supplied from the current loop 3, and a plurality of transmitter devices 1.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Transmitter device
2 Appliance
3 Current loop
4 Receiving device
5 Line resistance
6 Radio unit
7 Current sensor unit
8, 9 Filter unit
10 Control unit
11 Voltage preset unit
12 Voltage control unit
13 Direct-current converter
14 Modulator unit

What is claimed is:

1. A telecommunication device comprising:
a current loop;
a feeding receiving device;
a transmitter device, which is fed from the receiving device via the current loop, for outputting at least one variable measured value to be applied to the loop current, the transmitter device being configured for simultaneous bidirectional communication via the current loop; and
an additional appliance configured to be fed from the current loop, to bidirectionally communication via the current loop and, and to feed from the current loop,
wherein the additional appliance comprises control means for adaptive operating voltage matching to the loop current as a function of the instantaneous power demand,
wherein the control means reduce an operating voltage of the additional appliance in inverse proportion to the loop current, down to a minimum operating voltage value, when the loop current rises, and stabilize the operating voltage of the additional appliance, independent of the loop current, when the loop current rises further than when the control means reduces the operating voltage to the minimum operating voltage value.

2. The telecommunication device as claimed in claim 1, wherein the control means are implemented for adaptive operating voltage matching to an appliance which has a constant power consumption.

3. The telecommunication device as claimed in claim 1, wherein the control means are implemented in at least one appliance which communicates in a wire-free manner.

4. The telecommunication device as claimed in claim 3, wherein the control means carry out operating voltage matching, as a function of the power required for the wire-free data communication, for adaptation to fluctuating communication frequencies during wire-free data communication.

5. The telecommunication device as claimed in claim 1, wherein the control means comprise a current sensor unit configured to measure the instantaneous loop current in the current loop.

6. The telecommunication device as claimed in claim 5, wherein the control means comprise a filter unit, which is connected downstream from the current sensor unit, for separating a useful signal, which is used for operating voltage matching, in the low frequency range from a communication signal in the high frequency range.

7. The telecommunication device as claimed in claim 6, wherein the control means comprise a voltage preset unit, which is connected downstream from the filter unit, and which is configured to define the value for the operating voltage of the additional appliance in accordance with a predetermined U/I operating curve, on the basis of the instantaneous loop current.

8. The telecommunication device as claimed in claim 7, wherein the U/I operating curve of the voltage preset unit takes correcting account of further operating parameters in the adaptive operating voltage matching to the instantaneous power demand of the appliance,
wherein the operating parameters include at least one of: ambient temperature, component tolerances, safety margins, instantaneous power consumption.

9. The telecommunication device as claimed in claim 8, wherein the control means comprises a voltage control unit, which is connected downstream from the voltage preset unit, and which is configured to set the operating voltage for the additional appliance.

10. A method for supplying an operating voltage to appliances in a telecommunication device,
wherein the telecommunications device has a feeding receiving device, a current loop, and a transmitter device, which is fed via the current loop from the receiving device for outputting at least one variable measured value to be applied to the loop current, and
wherein the method comprises:
providing at least one additional appliance on the current loop;
adaptively matching an operating voltage of the additional appliance to an instantaneous loop current, such that the operating voltage is decreased in inverse proportion to the loop current, down to a minimum operating voltage value, when the loop current rises, and the operating voltage is stabilized at the minimum operating voltage value, independent of the loop current, when the loop current rises further than when the control means reduces the operating voltage to the minimum operating voltage value.

11. The telecommunications device as claimed in claim 1, wherein the telecommunications device is a telemetry device.

12. The method as claimed in claim 10, wherein the telecommunications device is a telemetry device.

13. A telecommunication device comprising:
a current loop;
a feeding receiving device;
a transmitter device, which is fed from the receiving device via the current loop, for outputting at least one variable measured value to be applied to the loop current, the transmitter device being configured for simultaneous bidirectional communication via the current loop; and
an additional appliance configured to be fed from the current loop, to bidirectionally communication via the current loop and, and to feed from the current loop,
wherein the additional appliance comprises a control device configured to adaptive match an operating voltage to the loop current as a function of the instantaneous power demand,
wherein the control device is configured to reduce an operating voltage of the additional appliance in inverse proportion to the loop current, down to a minimum operating voltage value, when the loop current rises, and stabilize the operating voltage of the additional appliance, independent of the loop current, when the loop current rises further than when the control means reduces the operating voltage to the minimum operating voltage value.

14. The telecommunication device as claimed in claim 13, wherein the control device is configured to adaptively match an operating voltage of the additional appliance to a constant power consumption.

15. The telecommunication device as claimed in claim 13, wherein the additional appliance communicates in a wire-free manner.

16. The telecommunication device as claimed in claim 15, wherein the control device is configured to perform operating voltage matching, as a function of the power required for the wire-free data communication, for adaptation to fluctuating communication frequencies during wire-free data communication.

17. The telecommunication device as claimed in claim 13, wherein the control device comprises a current sensor unit configured to measure the instantaneous loop current in the current loop.

18. The telecommunication device as claimed in claim 17, wherein the control device comprises a filter unit, which is connected downstream from the current sensor unit, for separating a useful signal, which is used for operating voltage matching, in the low frequency range from a communication signal in the high frequency range.

19. The telecommunication device as claimed in claim 18, wherein the control means comprises a voltage preset unit, which is connected downstream from the filter unit, and which is configured to define the value for the operating voltage of the additional appliance in accordance with a predetermined U/I operating curve, on the basis of the instantaneous loop current.

20. The telecommunication device as claimed in claim 19, wherein:
the U/I operating curve of the voltage preset unit takes correcting account of further operating parameters in the adaptive operating voltage matching to the instantaneous power demand of the appliance;
the operating parameters include at least one of: ambient temperature, component tolerances, safety margins, instantaneous power consumption; and
the control device comprises a voltage control unit, which is connected downstream from the voltage preset unit, and which is configured to set the operating voltage for the additional appliance.
